(19) United States
(12) Patent Application Publication
(10) Pub. No.: US 2019/0232625 A1
(43) Pub. Date: Aug. 1, 2019

(54) MULTILAYER COEXTRUDED FILM FOR CONTROLLING GREASE MIGRATION

(71) Applicant: Dow Global Technologies LLC, Midland, MI (US)

(72) Inventors: Felipe Martinez Barreneche, Freeport, TX (US); Nicolas Cardoso Mazzola, Jundiai (BR); Marcelo Delmar Cantu, Jundiai (BR); Felipe Dantas Barbosa, Jundiai (BR)

(73) Assignee: Dow Global Technologies LLC, Midland, MI (US)

(21) Appl. No.: 16/333,625

(22) PCT Filed: Sep. 8, 2017
(86) PCT No.: PCT/US2017/050604

§ 371 Date: Mar. 15, 2019

Related U.S. Application Data
(60) Provisional application No. 62/401,515, filed on Sep. 29, 2016.

(51) Int. Cl. B32B 27/30; B32B 27/32; B32B 27/08

(52) U.S. Cl. CPC B32B 27/302; B32B 7/12; B32B 27/08; B32B 27/32

(57) ABSTRACT

A multilayer coextruded film which includes at least one oil and grease absorbing layer and at least one oil barrier layer. The at least one oil and grease absorbing layer includes at least one styrenic block copolymer. Each oil barrier layer includes one or more polyolefins. Some multilayer coextruded films include an interior sealing layer. Further multilayer coextruded films include an exterior finishing layer with the oil barrier layer and the oil and grease absorbing layer disposed between the interior sealing layer and the exterior finishing layer.

### CROSS-REFERENCE TO RELATED APPLICATIONS

This application claims the benefit of U.S. Provisional Application Ser. 62/401,515, filed Sep. 29, 2016 which is hereby incorporated by reference in its entirety.

### TECHNICAL FIELD

Embodiments described herein relate generally to multilayer coextruded films, and more particularly to multilayer films with at least one oil barrier layer and at least one oil and grease absorbing layer. Such multilayer coextruded film can be used as packaging for oily or greasy items, while providing reduction of migration of oil and grease to external layers of the multilayer film.

### BACKGROUND

The retention of oil and grease within polymer film packages is currently a challenge. In consumer and manufacturing segments, the need to retain oil and grease within a package are common demands for sectors such as food pouches or packaging for pet food. Currently, high density polyethylene (HDPE) resins or polyamides (PA) are commonly relied upon to provide a barrier layer in a coextruded film to prevent migration of oil or grease to the exterior of packaging or to an intermediate lamination layer. However, a barrier layer is not impervious to oil and grease and migration of oil and grease is not entirely prevented such that over time the oil and grease is able to reach the exterior of the packaging.

A key desired attribute of a multilayer film for packaging oily or greasy items is minimizing the migration of the oil and grease and maximizing the time for oil or grease to pass through the multilayer film. However, as barrier layers with HDPE or PA, for example, are not impervious to oil and grease, alternative multilayer films are required to further improve packaging performance. Thus, there is a need in the art for alternative structures that further decrease the migration of oil or grease through a multilayer coextruded film.

### SUMMARY

Embodiments of the present disclosure meet those needs by providing multilayer coextruded films comprising at least one oil and grease absorbing layer in addition to an oil barrier layer. The multilayer coextruded films may be used as packaging, and more particularly as packaging for oily or greasy food products. The multilayer coextruded films exhibit reduced oil and grease migration and permeability properties with the addition of the at least one oil and grease absorbing layer to absorb and curb the migration of the oil or grease.

According to at least one embodiment of the present disclosure, a multilayer coextruded film is provided. The multilayer coextruded film includes at least one oil and grease absorbing layer and at least one oil barrier layer, wherein at least one oil and grease absorbing layer includes at least one styrenic block copolymer. Further, each oil barrier layer includes one or more polyolefins. In some embodiments the multilayer coextruded film also includes an interior sealing layer. In other embodiments the multilayer coextruded film additionally includes an exterior finishing layer, wherein the at least one oil barrier layer and the at least one oil and grease absorbing layer are disposed between the interior sealing layer and the exterior finishing layer.

According to additional embodiments of the present disclosure, a multilayer coextruded film is provided. The multilayer coextruded film includes at least one oil and grease absorbing layer, at least one oil barrier layer, and an interior sealing layer. The at least one oil and grease absorbing layer includes at least one styrenic block copolymer, at least one polyolefin elastomer, or combinations thereof. Further, each oil barrier layer includes one or more polyolefins. Further, at least one of the oil and grease absorbing layers is disposed between the interior sealing layer and the at least one oil barrier layer.

According to yet additional embodiments of the present disclosure, a multilayer coextruded film is provided. The multilayer coextruded film includes at least one oil and grease absorbing layer, at least one oil barrier layer, and an interior sealing layer. The at least one oil and grease absorbing layer includes at least one styrenic block copolymer, at least one polyolefin elastomer, or combinations thereof. Further, each oil barrier layer includes one or more polyolefins. Further, at least one of the oil barrier layers is disposed between the interior sealing layer and the at least one oil and grease absorbing layer.

These and other embodiments are described in more detail in the Detailed Description.

### BRIEF DESCRIPTION OF THE DRAWINGS

FIG. 1 is a schematic depicting the layer structure of a multilayer coextruded film with an interior sealing layer, an oil and grease absorbing layer, and an oil barrier layer in accordance with one or more embodiments of this disclosure.

FIG. 2 is a schematic depicting the layer structure of a multilayer coextruded film with an interior sealing layer, an oil and grease absorbing layer, an oil barrier layer, a core layer, and an exterior finishing layer in accordance with one or more embodiments of this disclosure.

FIG. 3 is a schematic depicting the layer structure of a multilayer coextruded film with an interior sealing layer, two oil and grease absorbing layers, an oil barrier layer, and an exterior finishing layer in accordance with one or more embodiments of this disclosure.

FIG. 4 is a schematic depicting the layer structure of a multilayer coextruded film with an interior sealing layer, an oil barrier layer, two oil and grease absorbing layers, and an exterior finishing layer in accordance with one or more embodiments of this disclosure.

FIG. 5 is a schematic depicting the layer structure of a multilayer coextruded film with an interior sealing layer, an oil and grease absorbing layer, two oil barrier layers, and an exterior finishing layer in accordance with one or more embodiments of this disclosure.

FIG. 6 is a schematic depicting the layer structure of a multilayer coextruded film with an interior sealing layer, an oil and grease absorbing layer, an oil barrier layer, an additional oil and grease absorbing layer, and an exterior finishing layer in accordance with one or more embodiments of this disclosure.

FIG. 7 is a schematic depicting the layer structure of a multilayer coextruded film with an interior sealing layer, an oil barrier layer, an oil and grease absorbing layer, an additional oil barrier layer, and an exterior finishing layer in accordance with one or more embodiments of this disclosure.

FIG. 8 is a schematic depicting the layer structure of a multilayer coextruded film with a combined interior sealing layer and oil and grease absorbing layer, and an oil barrier layer in accordance with one or more embodiments of this disclosure.

FIG. 9 is a graph depicting oil absorption in a multilayer film on a mass basis.

FIG. 10 is a graph depicting oil absorption in a multilayer film on an increase in film thickness basis.

### DETAILED DESCRIPTION

Reference will now be made in detail to various embodiments of the instantly disclosed multilayer coextruded films 10 which include a combination of oil barrier layer(s) 30 and oil and grease absorbing layer(s) 20. The multilayer coextruded film 10 can be used as packaging, such as food packaging, and is particularly suited for packaging of oily or greasy items. Embodiments of the multilayer coextruded film 10 may provide advantages over prior packaging as the multilayer coextruded film 10 is configured to retain oil and grease within a package formed from the multilayer coextruded film 10.

Unless otherwise indicated, the disclosure of any ranges in the specification and claims are to be understood as including the range itself and also anything subsumed therein, as well as endpoints.

In various embodiments, a multilayer coextruded film 10 includes a combination of at least one oil barrier layer 30 and at least one oil and grease absorbing layer 20. The oil and grease absorbing layer 20 includes at least one styrenic block copolymer, at least one polyolefin elastomer, or combinations thereof. The oil barrier layer 30 includes one or more polyolefins.

In one or more embodiments, a multilayer coextruded film 10 includes a combination of oil barrier layer(s) 30, oil and grease absorbing layer(s) 20 and additionally an interior sealing layer 40. The interior sealing layer 40 is provided on an interior surface of the multilayer coextruded film 10 when the multilayer coextruded film 10 is formed into a package. In one or more embodiments the oil and grease absorbing layer 20 is disposed between the interior sealing layer 40 and the oil barrier layer 30. A multilayer coextruded film 10 is formed with the interior sealing layer 40 and the oil barrier layer 30 providing the outermost layers and various combinations of additional oil barrier layers 30 and the oil and grease absorbing layer 20 providing layers therebetween. In further embodiments, the oil barrier layer 30 is disposed between the interior sealing layer 40 and the oil and grease absorbing layer 20. A multilayer coextruded film 10 is formed with the interior sealing layer 40 and the oil and grease absorbing layer 20 providing the outermost layers and various combinations of additional oil and grease absorbing layers 20 and the oil barrier layer 30 providing layers therebetween.

In various embodiments, a multilayer coextruded film 10 includes a combination of oil barrier layer(s) 30 and oil and grease absorbing layer(s) 20 as well as an interior sealing layer 40 and an exterior finishing layer 50. In one or more embodiments the oil barrier layer 30 and the oil and grease absorbing layer 20 are disposed between the interior sealing layer 40 and the exterior finishing layer 50. A multilayer coextruded film 10 is formed with the interior sealing layer 40 and the exterior finishing layer 50 providing the outermost layers and various combinations of the oil barrier layers 30 and the oil and grease absorbing layers 20 providing layers therebetween.

In one or more embodiments, the oil and grease absorbing layer 20 comprises at least one styrenic block copolymer. In various embodiments, the styrenic block copolymer is selected from styrene-butadiene-styrene, styrene-isoprene-styrene, styrene-ethylene/butylene-styrene, or combinations thereof. It will be appreciated by one having skill in the art that there are additional styrenic block copolymers which may equally be utilized as a component of the one oil and grease absorbing layer 20.

In various embodiments, the oil and grease absorbing layer 20 comprises 5 to 99% by weight styrenic block copolymer, 10 to 75% by weight styrenic block copolymer, 15 to 70% by weight styrenic block copolymer, 20 to 60% by weight styrenic block copolymer, or 30 to 55% by weight styrenic block copolymer.

In some embodiments, the oil and grease absorbing layer 20 comprises styrene-butadiene-styrene. In various embodiments, the oil and grease absorbing layer 20 comprises 5 to 99% by weight styrene-butadiene-styrene, 10 to 75% by weight styrene-butadiene-styrene, 15 to 70% by weight styrene-butadiene-styrene, 20 to 60% by weight styrene-butadiene-styrene, or 30 to 55% by weight styrene-butadiene-styrene.

In various embodiments, the oil and grease absorbing layer 20 comprises a polyolefin, for example and not by way of limitation, polypropylene, polyethylene, or combinations thereof. The polypropylene, polyethylene, or combinations thereof may be blended with the at least one styrenic block copolymer. In various embodiments, the oil and grease absorbing layer 20 comprises 20 to 99% by weight polyolefin, 25 to 75% by weight polyolefin, 30 to 70% by weight polyolefin, 35 to 65% by weight polyolefin, or 40 to 60% by weight polyolefin. Similarly, in various embodiments, the oil and grease absorbing layer 20 comprises 20 to 99% by weight polyethylene, 25 to 75% by weight polyethylene, 30 to 70% by weight polyethylene, 35 to 65% by weight polyethylene, or 40 to 60% by weight polyethylene. It will be appreciated that the oil and grease absorbing layer 20 may also comprise a combination of polyethylene and polypropylene at 20 to 99% by weight, 25 to 75% by weight, 30 to 70% by weight, 35 to 65% by weight, or 40 to 60% by weight.

Various polyethylene resins are contemplated herein. In various embodiments, the oil and grease absorbing layer 20 comprises polyethylene selected from high density polyethylene (HDPE), medium density polyethylene (MDPE), linear low-density polyethylene (LLDPE), enhanced polyethylene resins (EPE), ultra-low density polyethylene, or combinations thereof. Examples of suitable commercial polymers may include ELITE™ 5400 G (a LLDPE), ELITE™ 5960G (an EPE), ELITE™ 5940G (a MDPE), DOWLEX™ 2038.68 (a MDPE), ELITE™ 5400G (an EPE), DOWLEX™ 2045G (a LLDPE), and ATTANE™ 4203G (an ULDPE), each from The Dow Chemical Company, Midland, Mich.

In one or more embodiments, the oil and grease absorbing layer 20 comprises a functionalizer, for example maleic-anhydride, to form a functionalized polymer. In various embodiments, the oil and grease absorbing layer 20 comprises 1 to 40% by weight maleic-anhydride modified polyolefin, 2 to 35% by weight maleic-anhydride modified polyolefin, 3 to 30% by weight maleic-anhydride modified polyolefin, 5 to 25% by weight maleic-anhydride modified polyolefin, or 10 to 20% by weight maleic-anhydride modified polyolefin. The maleic-anhydride modified polyolefin may comprise 0.5 to 8% maleic-anhydride by weight. It will be appreciated that additional or substituted functionalizers may be utilized at the same or similar % by weight as discussed for maleic-anhydride to achieve the desired polymer characteristics. Without wishing to be bound by theory, it is believed that the carboxyl group which is part of maleic anhydride reacts with the —OH functional group in grease and oil products. The interaction between the —OH functional group in grease and oil products and the carboxyl group in the maleic anhydride improves grease retention as the entire grease product is retained by the maleic anhydride containing polymer along with the —OH group.

In some embodiments, the oil and grease absorbing layer 20 comprises a polyolefin elastomer in addition to or as a substitute for styrenic block copolymer. A suitable commercial may be ENGAGE™ polyolefin elastomers from The Dow Chemical Company, Midland, Mich. In further embodiments, anhydride modified copolymers based on styrenic and ethylenic copolymers may be utilized in the oil and grease absorbing layer 20. A suitable commercial may be OREVAC® 18910 from Arkema, Colombes, France.

In other embodiments, the oil and grease absorbing layer 20 comprises a blend of styrenic block copolymer (for example, styrene-butadiene-styrene), polyolefin (for example, polyethylene), and weight maleic-anhydride. It will be appreciated that the disclosed weight percentages for the components of the oil and grease absorbing layer 20 may be viewed in combination to provide numerous overall compositions of the oil and grease absorbing layer 20. For example, the multilayer coextruded film 10 may have at least one oil and grease absorbing layer 20 comprising 20 to 50% by weight styrene-butadiene-styrene, 35 to 65% by weight polyethylene, and 5 to 25% by weight maleic-anhydride modified polyolefin. One suitable commercial example is AMPLIFY™ TY 3351 B from The Dow Chemical Company, Midland, Mich. Additionally, it will be appreciated that each oil and grease absorbing layer 20 in a multilayer coextruded film 10 having multiple oil and grease absorbing layers 20 may have distinct compositions to provide differing properties including flexural modulus, melting point, oil absorptivity, and elasticity for example.

As stated above, the oil barrier layer 30 may comprise one or more polyolefins. The polyolefins may include homopolymers or polymers comprising one or more of C₂-C₁₂ polymers, for example, polyethylene and polypropylene. In various embodiments, the oil barrier layer 30 comprises polyethylene selected from high density polyethylene, medium density polyethylene, linear low-density polyethylene, ultra-low density polyethylene, or combinations thereof. Examples of suitable commercial polymers may include ELITE™ 5400 G (a LLDPE), ELITE™ 5960G (a HDPE), ELITE™ 5940G (a MDPE), DOWLEX™ 2038.68 (a MDPE), ELITE™ 5400G (an EPE), DOWLEX™ 2045G (a LLDPE), and ATTANE™ 4203G (an ULDPE), each from The Dow Chemical Company, Midland, Mich.

The interior sealing layer 40 provides a coextruded film layer configured to allow thermal sealing of a folded multilayer coextruded film 10 into a hermetically sealed package. In various embodiments, the interior sealing layer 40 comprises polyethylene including linear low-density polyethylene, ethylene vinyl acetate (EVA), polyolefin plastomers (POP), or combinations thereof. Suitable commercial examples include the AFFINITY™, SEALUTION™, and VERSIFY™ products from The Dow Chemical Company, Midland, Mich. Specific additional suitable commercial examples include DOWLEX™ 2045G (a LLDPE), ELITE™ 5400G (an EPE), ELITE™ AT 6202, ELITE™ AT 6401, and Affinity™ 1880. In some embodiments, the interior sealing layer 40 comprises EVA resins with a vinyl acetate content of 3 to 20% by weight. For example, an EVA resin with a vinyl acetate content of 4, 9, 12, or 18% by weight.

In various embodiments, the exterior finishing layer 50 comprises polyethylene including linear low-density polyethylene, high density polyethylene, medium density polyethylene, ultra-low density polyethylene, low-density polyethylene (LDPE), mettalocene linear low-density polyethylene (mLLDPE), ethylene vinyl acetate, polyolefin plastomers, or combinations thereof. Examples of suitable commercial polymers may include ELITE™ 5400 G (a LLDPE), ELITE™ 5960G (an EPE), ELITE™ 5940G (a MDPE), DOWLEX™ 2038.68 (a MDPE), and DOWLEX™ 2045G (a LLDPE), each from The Dow Chemical Company, Midland, Mich.

In certain embodiments, the interior sealing layer 40 and the exterior finishing layer 50 are the same polyolefin. In other embodiments, the interior sealing layer 40 and the exterior finishing layer 50 are different polyolefins.

In some embodiments, the multilayer coextruded film 10 may include a core layer 60. The core layer 60 may provide additional desirable characteristics to the multilayer coextruded film 10 not necessarily provided by the remaining layers of the multilayer coextruded film 10. For example, the core layer 60 may provide an ultraviolet (UV) barrier, an oxygen barrier, increased opacity or translucency of the multilayer coextruded film 10, antibacterial properties, or any other desirable property for polymer films known to those having skill in the art. Further, the core layer 60 may provide additional film thickness or rigidity to the overall multilayer coextruded film 10 without requiring the potentially more costly polymers utilized for the exterior finishing layer 50, the oil and grease absorbing layer 20, the oil barrier layer 30, or the interior sealing layer 40. It will further be appreciated that the above mentioned properties may also potentially be achieved through the addition of additives or resin blends to one or more of the exterior finishing layer 50, the oil and grease absorbing layer 20, the oil barrier layer 30, or the interior sealing layer 40.

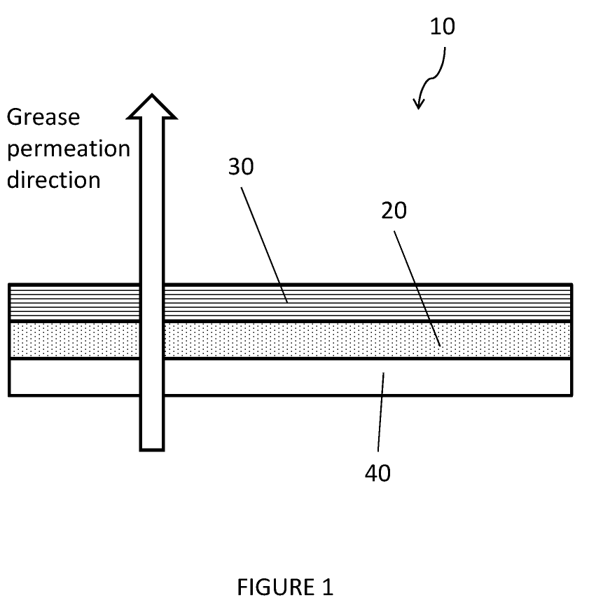

As previously discussed, the distinct layers of the multilayer coextruded film 10 may be arranged in numerous sequences. Specifically, the potential combinations of the oil and grease absorbing layer 20 and the oil barrier layer 30, in addition to the interior sealing layer 40 and exterior finishing layer 50 when present, are abundant. With reference to FIG. 1, a schematic of the layer structure of the multilayer coextruded film 10 according to some embodiments is provided. The multilayer coextruded film 10 includes an interior sealing layer 40, a single oil and grease absorbing layer 20, and a single oil barrier layer 30 arranged in a manner such that grease permeation would be from the interior sealing layer 40, through the oil and grease absorbing layer 20, and finally to the oil barrier layer 30.

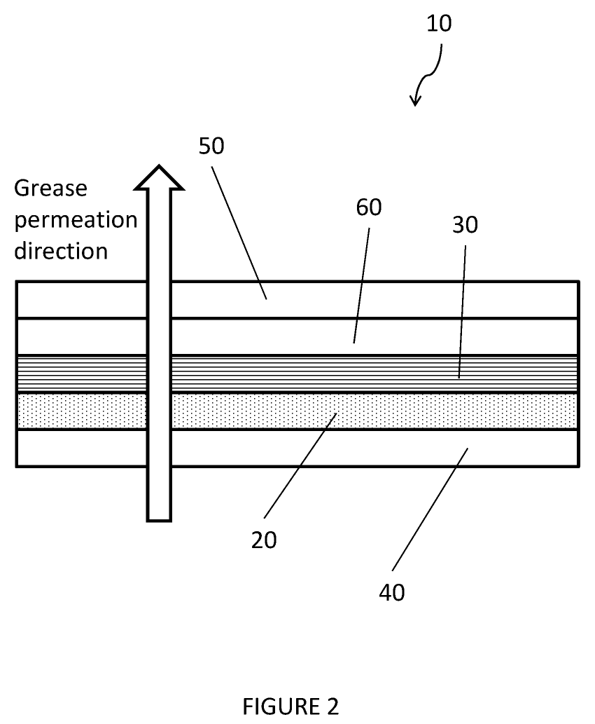

With reference to FIG. 2, a schematic of the layer structure of the multilayer coextruded film 10 according to some embodiments is provided. The multilayer coextruded film 10 includes an interior sealing layer 40, a single oil and grease absorbing layer 20, a single oil barrier layer 30, a single core layer 60, and an exterior finishing layer 50 arranged in a manner such that grease permeation would be from the interior sealing layer 40, through the intermediate layers, and finally to the exterior finishing layer 50.

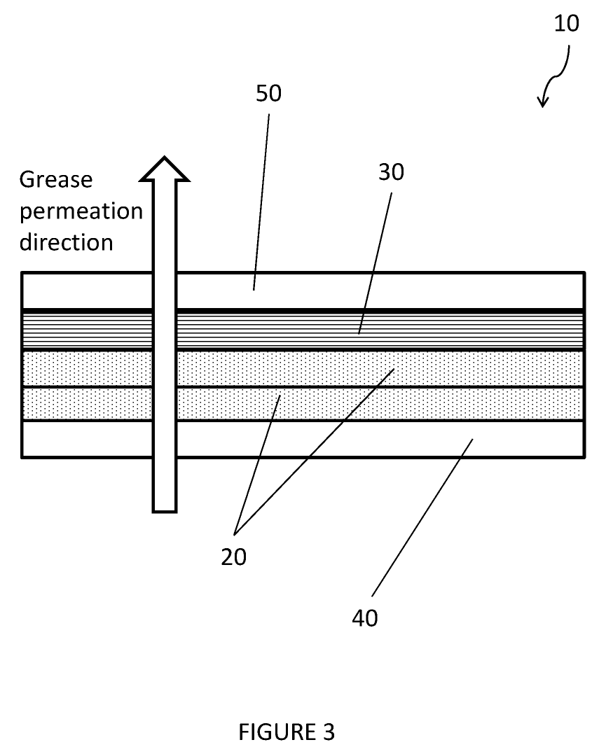

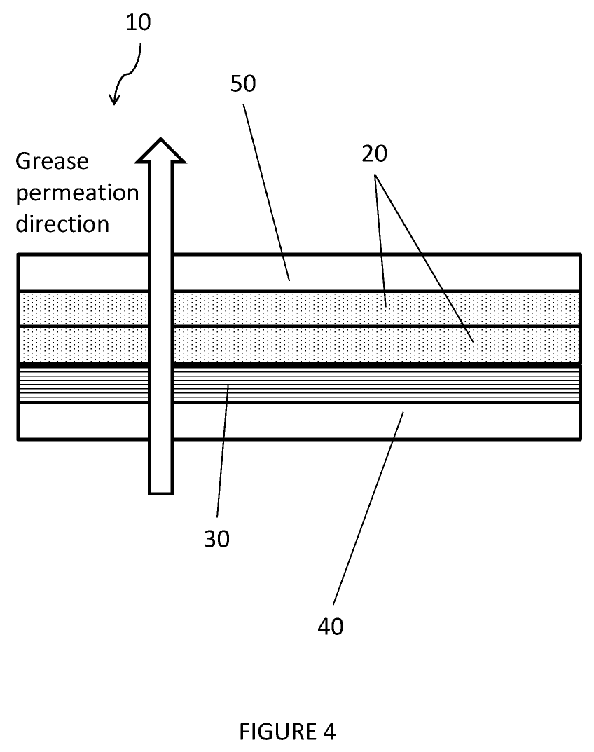

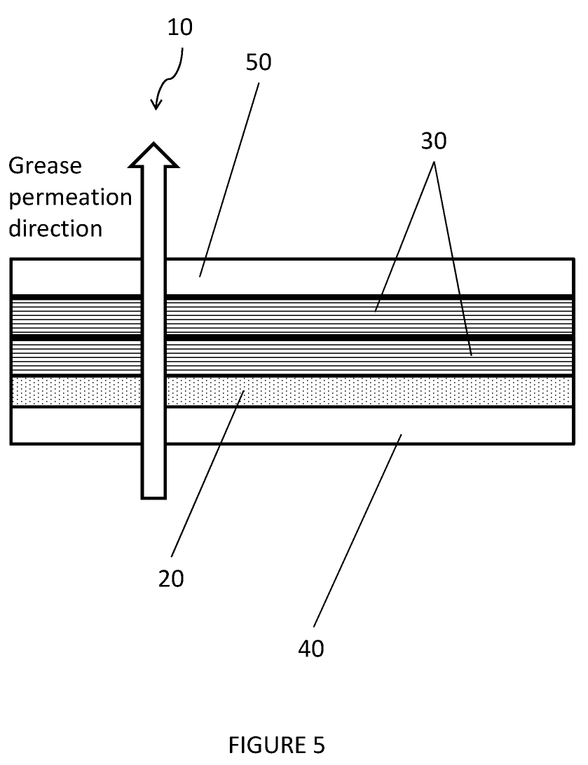

With reference to FIGS. 3, 4, and 5, schematics of the layer structure of the multilayer coextruded film 10 according to multiple embodiments are provided. As shown in FIGS. 3 and 4, in some embodiments, the multilayer coextruded film 10 includes an interior sealing layer 40, two oil and grease absorbing layers 20, a single oil barrier layer 30, and an exterior finishing layer 50. The two oil and grease absorbing layers 20 may be more proximal the interior sealing layer 40 that the oil barrier layer 30 as illustrated in FIG. 3 or the oil barrier layer 30 may be more proximal the interior sealing layer 40 than the two oil and grease absorbing layers 20 as illustrated in FIG. 4. Similarly, as shown in FIG. 5, in some embodiments, the multilayer coextruded film 10 includes an interior sealing layer 40, a single oil and grease absorbing layer 20, two oil barrier layers 30, and an exterior finishing layer 50. Albeit not illustrated, it will be appreciated that the two oil barrier layers 30 may also be more proximal the interior sealing layer 40 than the oil and grease absorbing layer 20. The layers in each case are arranged in a manner such that grease permeation would be from the interior sealing layer 40, through the intermediate layers, and finally to the exterior finishing layer 50. It will be appreciated that additional oil and grease absorbing layers 20, additional oil barrier layers 30, one or more core layers 60, or combinations thereof may be added to create a multilayer coextruded film 10 with more than the five layers shown in FIGS. 3, 4, and 5. For example, the multilayer coextruded film 10 may include an interior sealing layer 40, three oil and grease absorbing layers 20, two oil barrier layers 30, and an exterior finishing layer 50.

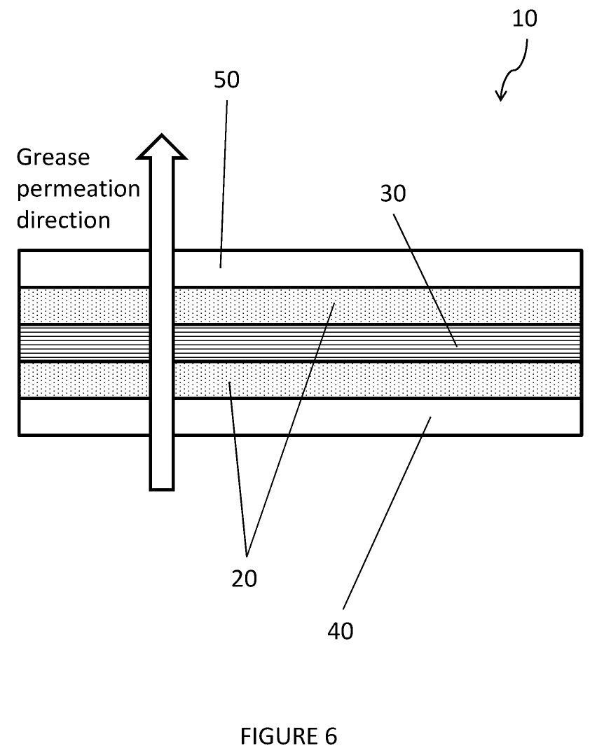

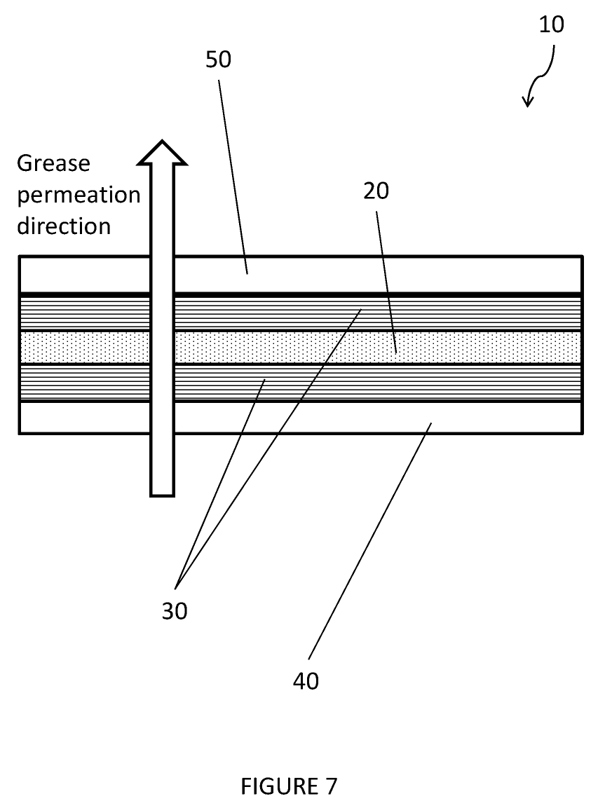

With reference to FIGS. 6 and 7, schematics of the layer structure of the multilayer coextruded film 10 according to multiple embodiments are provided. As shown in FIG. 5, in some embodiments, the multilayer coextruded film 10 includes an interior sealing layer 40, two oil and grease absorbing layers 20, a single oil barrier layer 30, and an exterior finishing layer 50 where the oil barrier layer 30 is disposed between the two oil and grease absorbing layers 20. Similarly, as shown in FIG. 6, in some embodiments, the multilayer coextruded film 10 includes an interior sealing layer 40, a single oil and grease absorbing layer 20, two oil barrier layers 30, and an exterior finishing layer 50 where the oil and grease absorbing layer 20 is disposed between the two oil barrier layers 30. The layers in each case are arranged in a manner such that grease permeation would be from the interior sealing layer 40, through the intermediate layers, and finally to the exterior finishing layer 50. It will be appreciated that additional oil and grease absorbing layers 20, additional oil barrier layers 30, one or more core layers 60, or combinations thereof may be added to create a multilayer coextruded film 10 with more than the five layers shown in FIGS. 6 and 7. For example, the multilayer coextruded film 10 may include an interior sealing layer 40, three oil and grease absorbing layers 20, two oil barrier layers 30, and an exterior finishing layer 50 where the oil barrier layer 30 is disposed between a set of two oil and grease absorbing layers 20 and a single oil and grease absorbing layer 20.

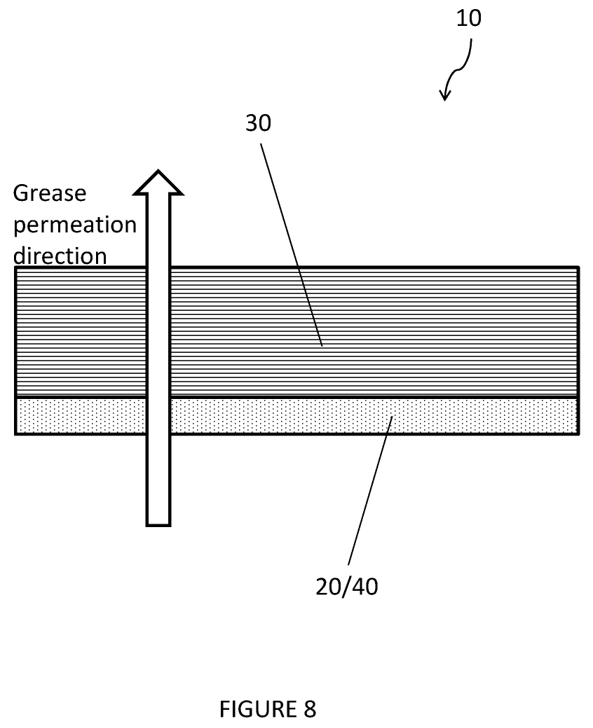

In some embodiments, the interior sealing layer 40 and an inner-most of the oil and grease absorbing layers 20 is combined into a single layer. Specifically, the single layer serves the function of both the interior sealing layer 40 and the oil and grease absorbing layer 20. As such, the oil and grease absorbing layer 20 includes an interior sealing layer 40 at an interior surface. With reference to FIG. 8, a schematic of the layer structure of the multilayer coextruded film 10 according to some embodiments with a combined oil and grease absorbing layer 20 and interior sealing layer 40 is provided. A suitable commercial polymer for a combined oil and grease absorbing layer 20 and interior sealing layer 40 in non-food contact applications may be AMPLIFY™ TY 3351B from The Dow Chemical Company, Midland, Mich. Additionally, a combined oil and grease absorbing layer 20 and interior sealing layer 40 may comprise a functional ethylene copolymer, for example, ethylene-vinyl acetate (EVA), ethylene acrylic acid (EAA), or ethyl methacrylate (EMA). Further, a combined oil and grease absorbing layer 20 and interior sealing layer 40 may comprise a POP such as an AFFINITY™ product from The Dow Chemical Company, Midland, Mich. It will be appreciated that additional oil and grease absorbing layers 20, oil barrier layers 30, core layers 60, or an exterior finishing layer 50 may be added to the schematic of FIG. 8 without departing from the scope of this disclosure.

In various embodiments, the multilayer coextruded films 10 can include 2, 3, 4, 5, 6, 7, 8, 9, 10, 11, even 30 layers. In many instances, the application of the multilayer coextruded film 10 may dictate the number of layers to be used. In certain embodiments, each layer can have a thickness of about 2 to about 75 microns. In other embodiments, each can have a thickness of about 3 to about 50 microns. In further embodiments, each layer can have a thickness of about 5 to about 30 microns.

In various embodiments, the multilayer coextruded film 10 includes a toner or ink image printed on the exterior finishing layer 50. The exterior finishing layer 50 may be printed using machinery and processes known in the art. By way of example and not limitation, the exterior finishing layer 50 may be printed by using corona printing, a digital press, and liquid toner/ink.

It should be understood that any of the films within the multilayer coextruded film 10 may contain various additives. Examples of such additives include antioxidants, ultraviolet light stabilizers, thermal stabilizers, slip agents, antiblock pigments or colorants, processing aids (such as fluoropolymers), crosslinking catalyst, flame retardants, fillers, foaming agents, and combinations thereof.

In order that various embodiments may be more readily understood, reference is made to the following examples which are intended to illustrate various embodiments, but do not limit the scope thereof.

The resins used for the production of the films are listed in Table 1 below.

TABLE 1
Resins used for film production

| | | | Melt Index | |
|---|---|---|---|---|
| | | | (190° C. | |
| | Commercial | | 2.16 kg) | Density |
| Name | Name | Type | (g/10 min) | (g/cm³) |
| Resin | AMPLIFY ™ TY | Maleic anhydride | 3.0 | 0.94 |
| 1 | 3351B | grafted (MAH) | | |
| | | polyolefin-styrenic | | |
| | | block copolymer | | |
| | | blend | | |
| Resin | ELITE ™ 5960 | Enhanced high | 0.85 | 0.962 |
| 2 | | density | | |
| | | polyethylene | | |
| Resin | DOWLEX ™ | Ziegler-Natta | 1.00 | 0.920 |
| 3 | 2045G | catalyzed linear | | |
| | | low density | | |
| | | polyethylene | | |

Film structures, which can include the resins of Table 1, are listed in Table 2 below. Multilayer films were prepared with a 5 layer arrangement to compare the grease barrier and absorptive characteristics of each of the three resins. The multilayer film thickness was set at 100 micrometers (μm) with each outside layer being 24.5 μm and each of the 3 internal layers being 17.0 μm. The multilayer film was coextruded to produce a multilayer film with the specified properties.

TABLE 2
Film structures

| | | Sample 1 | Sample 2 | |
|---|---|---|---|---|
| Sample Number | | (Comparative) | (Comparative) | Sample 3 |
| LAYER | 24.5 μm | DOWLEX ™ | DOWLEX ™ | DOWLEX ™ |
| 1 | | 2045G | 2045G | 2045G |
| LAYER | 17.0 μm | DOWLEX ™ | ELITE ™ | AMPLIFY ™ TY |
| 2 | | 2045G | 5960 | 3351B |
| LAYER | 17.0 μm | DOWLEX ™ | ELITE ™ | AMPLIFY ™ TY |
| 3 | | 2045G | 5960 | 3351B |
| LAYER | 17.0 μm | DOWLEX ™ | ELITE ™ | AMPLIFY ™ TY |
| 4 | | 2045G | 5960 | 3351B |
| LAYER | 24.5 μm | DOWLEX ™ | DOWLEX ™ | DOWLEX ™ |
| 5 | | 2045G | 2045G | 2045G |

Each of samples 1, 2, and 3 were tested for grease permeation resistance. The testing of each sample was in accordance with ASTM method F119-82 which provides a test to measure rate of grease permeation of flexible packaging materials—(Rapid test). The testing procedure consists of preparing five 5×5 cm films samples and placing them on a clean ground-glass backing plate. A 20-mm diameter cotton flannel rifle cleaning patch disk is placed on top of each sample and over the cotton patch is placed a 50 gram (g) weight. The entire assembly (glass, test specimen, cotton disk and weight) are pre-heated to 60° C. for 30 minutes (min). With the assembly still in the heated oven, the weights are removed, six drops of melted chicken fat is added to each cotton disk, and the weights are returned to the oiled patches. At periodic intervals of every 15 min for the first hour, every 30 min for the next 4 hours (h), and 1 time a day thereafter, the ground-glass plate surface is observed against a dark background. The time at which the first trace of wetting indicated by a reduction in light scattering in the ground-glass backing plate is visible at the position of the weight is recorded as failure time. The average, maximum and minimum time to failure are reported. The results of the grease permeation resistance testing are provided in Table 3 below.

TABLE 3
Chicken Grease Permeation Resistance (ASTM method F119-82)

| Sample | Layer Description | Time to Fail (hours) at 60° C. | |
|---|---|---|---|
| Sample 1 | DOWLEX ™ 2045G | 48 | hours |
| | DOWLEX ™ 2045G | | |
| | DOWLEX ™ 2045G | | |
| | DOWLEX ™ 2045G | | |
| | DOWLEX ™ 2045G | | |
| Sample 2 | DOWLEX ™ 2045G | 168 | hours |
| | ELITE ™ 5960 | | |
| | ELITE ™ 5960 | | |
| | ELITE ™ 5960 | | |
| | DOWLEX ™ 2045G | | |
| Sample 3 | DOWLEX ™ 2045G | 168 | hours |
| | AMPLIFY ™ TY 3351B | | |
| | AMPLIFY ™ TY 3351B | | |
| | AMPLIFY ™ TY 3351B | | |
| | DOWLEX ™ 2045G | | |

The chicken grease permeation resistance outlined in table 3 for each of samples 1, 2, and 3 demonstrates a comparative grease permeation resistance for the ELITE™ 5960 and the AMPLIFY™ TY 3351 B. The AMPLIFY™ TY 3351 B which includes a styrenic block copolymer provides similar grease permeation resistance as a traditional HDPE barrier material in ELITE™ 5960 and a superior resistance to DOWLEX™ 2045G LLDPE.

Each of samples 1, 2, and 3 were also tested for water vapor transmission rate (WVTR). The testing was completed at a temperature of 37.8° C. and a relative humidity of 100%. The results of the water vapor permeation testing are provided in Table 4 below.

TABLE 4
WVTR Permeation

| | | Film | | Standard |
|---|---|---|---|---|
| | | Thickness | WVTR | Deviation |
| Sample | Layer Description | (μm) | (g/m²-day) | (g/m²-day) |
| Sample | DOWLEX ™ 2045G | 104 | 2.140 | 0.0566 |
| 1 | DOWLEX ™ 2045G | | | |
| | DOWLEX ™ 2045G | | | |
| | DOWLEX ™ 2045G | | | |
| | DOWLEX ™ 2045G | | | |
| Sample | DOWLEX ™ 2045G | 102 | 1.080 | 0.0424 |
| 2 | ELITE ™ 5960 | | | |
| | ELITE ™ 5960 | | | |
| | ELITE ™ 5960 | | | |
| | DOWLEX ™ 2045G | | | |
| Sample | DOWLEX ™ 2045G | 100 | 2.890 | 0.0707 |
| 3 | AMPLIFY ™ TY 3351B | | | |
| | AMPLIFY ™ TY 3351B | | | |
| | AMPLIFY ™ TY 3351B | | | |
| | DOWLEX ™ 2045G | | | |

The water vapor permeation testing demonstrates the moisture barrier properties of Sample 2, which includes ELITE™ 5960, are improved relative to the baseline of DOWLEX™ 2045G. The oil barrier layer 30 not only reduces transmission of oil it also reduces transmission of moisture. It may also be noted from the water vapor permeation testing that Sample 3, which includes AMPLIFY™ TY 3351 B and represents the oil and grease absorbing layer 20, demonstrates an increased transmission of moisture compared to the baseline of DOWLEX™ 2045G. However, it may be understood that the combination of the oil barrier layer 30 (Samples 2) and the oil and grease absorbing layer 20 (Sample 3) have a synergy with one resulting in an increase in moisture transmission and the other resulting in a relative decrease in moisture transmission yielding a final film with acceptable moisture transmission resistance. It is noted that minimizing moisture transmission may be desirable because many greasy snack foods are also crunchy and transmission of moisture into the package would result in the greasy snack food becoming soggy.

The ELITE™ 5960 and the AMPLIFY™ TY 3351 B were further tested in combination to provide the inventive synergistic relationship of an oil barrier layer 30 and an oil and grease absorbing layer 20 in combination. Multilayer films were prepared with a 5 layer arrangement to compare the grease permeation resistance of multilayer films formed from the DOWLEX™ 2045G, the ELITE™ 5960, and the AMPLIFY™ TY 3351B in varying orders. The multilayer film thickness was set at 100 micrometers (μm) with each outside layer being 24.5 μm and each of the 3 internal layers being 17.0 μm. The multilayer film was coextruded to produce a multilayer film with the specified properties.

TABLE 5
Film structures

| | | Sample Number | | | | |
|---|---|---|---|---|---|---|
| | | Sample 4 | Sample 5 | Sample 6 | Sample 7 | Sample 8 |
| LAYER 1 | 24.5 μm | DOWLEX ™ | DOWLEX ™ | DOWLEX ™ | DOWLEX ™ | AMPLIFY ™ |
| | | 2045G | 2045G | 2045G | 2045G | TY 3351B |
| LAYER 2 | 17.0 μm | ELITE ™ | AMPLIFY ™ | AMPLIFY ™ | ELITE ™ | AMPLIFY ™ |
| | | 5960 | TY 3351B | TY 3351B | 5960 | TY 3351B |
| LAYER 3 | 17.0 μm | AMPLIFY ™ | ELITE ™ | ELITE ™ | AMPLIFY ™ | AMPLIFY ™ |
| | | TY 3351B | 5960 | 5960 | TY 3351B | TY 3351B |
| LAYER 4 | 17.0 μm | ELITE ™ | AMPLIFY ™ | ELITE ™ | AMPLIFY ™ | AMPLIFY ™ |
| | | 5960 | TY 3351B | 5960 | TY 3351B | TY 3351B |
| LAYER 5 | 24.5 μm | DOWLEX ™ | DOWLEX ™ | DOWLEX ™ | DOWLEX ™ | AMPLIFY ™ |
| (Seal) | | 2045G | 2045G | 2045G | 2045G | TY 3351B |

Each of samples 4, 5, 6, 7, and 8 were tested for grease permeation resistance. The testing of each sample was in accordance with ASTM method F119-82 which provides a test to measure rate of grease permeation of flexible packaging materials—(Rapid test). Testing was complete in accordance with the procedures utilized for samples 1, 2, and 3 described supra. The results of the grease permeation resistance testing are provided in Table 6 below.

TABLE 6
Chicken Grease Permeation Resistance (ASTM method F119-82)

| | Layer Description | Average | | Lowest | Highest |
|---|---|---|---|---|---|
| | (Grease Migration | Time to Fail | | Time to Fail | Time to Fail |
| Sample | from bottom to top) | at 60° C. | | at 60° C. | at 60° C. |
| Sample 4 | DOWLEX ™ 2045G | 168 | hours | — | 168 hours |
| | ELITE ™ 5960 | | | | (5 specimens) |
| | AMPLIFY ™ TY 3351B | | | | |
| | ELITE ™ 5960 | | | | |
| | DOWLEX ™ 2045G | | | | |
| Sample 5 | DOWLEX ™ 2045G | 269 | hours | 168 hours | 336 hours |
| | AMPLIFY ™ TY 3351B | | | (2 specimens) | (3 specimens) |
| | ELITE ™ 5960 | | | | |
| | AMPLIFY ™ TY 3351B | | | | |
| | DOWLEX ™ 2045G | | | | |
| Sample 6 | DOWLEX ™ 2045G | 96 | hours | — | 96 hours |
| | AMPLIFY ™ TY 3351B | | | | (5 specimens) |
| | ELITE ™ 5960 | | | | |
| | ELITE ™ 5960 | | | | |
| | DOWLEX ™ 2045G | | | | |
| Sample 7 | DOWLEX ™ 2045G | 317 | hours | 264 hours | 360 hours |
| | ELITE ™ 5960 | | | (2 specimens) | (3 specimens) |
| | AMPLIFY ™ TY 3351B | | | | |
| | AMPLIFY ™ TY 3351B | | | | |
| | DOWLEX ™ 2045G | | | | |
| Sample 8 | AMPLIFY ™ TY 3351B | 67 | hours | 48 hours | 96 hours |
| | AMPLIFY ™ TY 3351B | | | (3 specimens) | (2 specimens) |
| | AMPLIFY ™ TY 3351B | | | | |
| | AMPLIFY ™ TY 3351B | | | | |
| | AMPLIFY ™ TY 3351B | | | | |

The chicken grease permeation resistance testing of sample 4, 5, 6, 7, and 8 demonstrate the synergistic improvement to grease permeation resistance with a combination of the ELITE™ 5960 and the AMPLIFY™ TY 3351B layers. Specifically, the ELITE™ 5960 and the AMPLIFY™ TY 3351 B layers when provided individually as in samples 2 and 3 demonstrated a time to failure of 168 hours, whereas numerous combinations of the ELITE™ 5960 and the AMPLIFY™ TY 3351 B layers demonstrated the same or improved results. It is particularly noted from the chicken grease permeation resistance testing of sample 4, 5, 6, 7, and 8 that providing at least one AMPLIFY™ TY 3351 B layer (oil and grease absorbing layer 20) before the final ELITE™ 5960 layer (oil barrier layer 30) provided improved results. Specifically, sample 7 provides two oil and grease absorbing layers 20 (AMPLIFY™ TY 3351B) before the oil barrier layer 30 (ELITE™ 5960) resulting in an average time to fail of 317 hours. Similarly, sample 5 provides one oil and grease absorbing layer 20 (AMPLIFY™ TY 3351 B) before the single oil barrier layer 30 (ELITE™ 5960) and a second oil and grease absorbing layer 20 (AMPLIFY™ TY 3351 B) after the single oil barrier layer 30 (ELITE™ 5960) resulting in an average time to fail of 269 hours.

Additionally, testing of the rate of oil absorption by the multilayer film was undertaken. The testing procedure consists of preparing 10×10 cm film samples and immersing the film samples in a soybean oil filled jar. The jars with the film samples were placed in an oven at 60° C. The initial mass and thickness of films were recorded. At periodic intervals of 1 hour, 3 hours, 1 day, 5 days, 8 days, and 9 days, the samples were recovered from the jar and placed between two oil absorbent papers and submitted to a light pressure for a few seconds to remove the excess of oil from the film surface. Then, the mass and thickness of each film were measured to check the oil absorption. The oil absorption rate of the sample was then calculated according to the following formula:

$$Absorption rate = \frac{weight of swelled sample - weight of initial sample}{weight of initial sample}$$

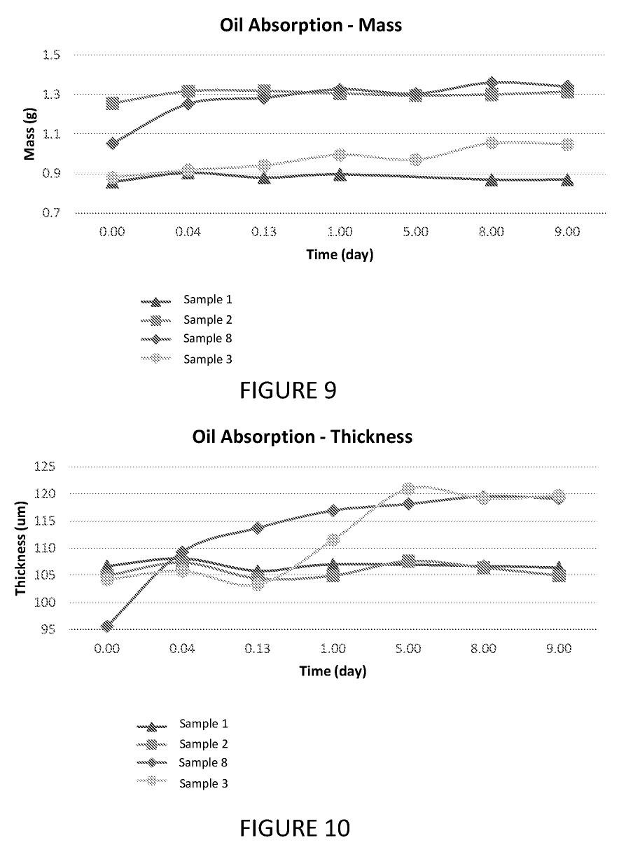

The results of the oil absorption testing are provided in Table 7 below and FIGS. 9 and 10.

TABLE 7
Oil Absorption Rate

| | Absorption | % Increase in | % Increase in |
|---|---|---|---|
| | rate after 9 | weight after 9 | thickness |
| Sample | days (g/g) | days | after 9 days |
| Sample 1 | 0.01 | 1.4 | −0.3 |
| (100% DOWLEX ™ | | | |
| 2045G) | | | |
| Sample 8 | 0.29 | 27.6 | 24.6 |
| (100% AMPLIFY ™ TY | | | |
| 3351B) | | | |
| Sample 2 | 0.06 | 4.7 | 0.0 |
| (DOWLEX ™ | | | |
| 2045G/ELITE ™ | | | |
| 5960/DOWLEX ™ | | | |
| 2045G | | | |
| Sample 3 | 0.17 | 19.1 | 14.9 |
| (DOWLEX ™ 2045G/ | | | |
| AMPLIFY ™ TY | | | |
| 3351B/DOWLEX ™ | | | |
| 2045G) | | | |

The oil absorption testing demonstrates that both the DOWLEX™ 2045 G (interior sealing layer 40 and exterior finishing layer 50) and the ELITE™ 5960 (oil barrier layer 30) substantially do not absorb oil. In the multilayer films of Examples 1-8, substantially all the oil absorption is the result of the AMPLIFY™ TY 3351B (oil and grease absorbing layer 20). The oil absorption testing also demonstrates the reduction in the rate of oil absorption from encapsulating the oil and grease absorbing layer 20 (AMPLIFY™ TY 3351 B) with polyolefins such as DOWLEX™ 2045G as the % increase in both weight and thickness is reduced compared to unencapsulated samples.

It should be understood that the various aspects of a multilayer coextruded film are described and such aspects may be utilized in conjunction with various other aspects.

In a first aspect, the disclosure provides a multilayer coextruded film. The multilayer coextruded film includes at least one oil and grease absorbing layer and at least one oil barrier layer. The at least one oil and grease absorbing layer comprises at least one styrenic block copolymer. Each oil barrier layer comprises one or more polyolefins lubricant package for water based drilling fluids.

In a second aspect, the disclosure provides the multilayer coextruded film of the first aspect, in which the multilayer coextruded film further comprises an interior sealing layer.

In a third aspect, the disclosure provides the multilayer coextruded film of the first or second aspect, in which the multilayer coextruded film further comprises an exterior finishing layer, where the at least one oil barrier layer and the at least one oil and grease absorbing layer are disposed between the interior sealing layer and the exterior finishing layer.

In a fourth aspect, the disclosure provides the multilayer coextruded film of any of the first through third aspects, in which at least one of the oil and grease absorbing layers is disposed between the interior sealing layer and the at least one oil barrier layer.

In a fifth aspect, the disclosure provides the multilayer coextruded film of any of the first through fourth aspects, in which at least one of the oil barrier layers is disposed between the interior sealing layer and the at least one oil and grease absorbing layer.

In a sixth aspect, the disclosure provides the multilayer coextruded film of any of the first or third through fifth aspects, in which at least one oil and grease absorbing layer includes an interior sealing layer at an interior surface.

In a seventh aspect, the disclosure provides the multilayer coextruded film of any of the first through sixth aspects, in which the at least one oil and grease absorbing layer comprises at least one styrenic block copolymer.

In an eighth aspect, the disclosure provides the multilayer coextruded film of any of the first through sixth aspects, in which the at least one oil and grease absorbing layer comprises a blend of styrenic block copolymers and polyolefins, particularly a blend of styrenic block copolymer and polyolefins selected from polyethylene or polypropylene, and more particularly a blend of styrenic block copolymers and polyethylene.

In a ninth aspect, the disclosure provides the multilayer coextruded film of the eighth aspect, in which the at least one oil and grease absorbing layer further comprises maleic-anhydride grafted polyolefin.

In a tenth aspect, the disclosure provides the multilayer coextruded film of any of the seventh through ninth aspects, in which the styrenic block copolymer is selected from styrene-butadiene-styrene, styrene-isoprene-styrene, styrene-ethylene/butylene-styrene, or combinations thereof, or particularly styrene-butadiene-styrene.

In an eleventh aspect, the disclosure provides the multilayer coextruded film of any of the first through tenth aspects, in which the at least one oil and grease absorbing layer comprises 5 to 99% by weight styrenic block copolymer, or particularly 20 to 70% by weight styrenic block copolymer.

In a twelfth aspect, the disclosure provides the multilayer coextruded film of any of the first through sixth aspects, in which the at least one oil and grease absorbing layer comprises 20 to 50% by weight styrene-butadiene-styrene, 35 to 65% by weight polyethylene, and 5 to 25% by weight maleic-anhydride grafted polyolefin.

In a thirteenth aspect, the disclosure provides the multilayer coextruded film of any of the first through twelfth aspects, in which the at least one oil barrier layer comprises 20 to 99% polyethylene, the polyethylene selected from high density polyethylene, medium density polyethylene, linear low-density polyethylene, polypropylene, ultra-low density polyethylene, or combinations thereof.

In a fourteenth aspect, the disclosure provides the multilayer coextruded film of any of the first through thirteenth aspects, in which the interior sealing layer comprises a polyolefin material.

In a fifteenth aspect, the disclosure provides the multilayer coextruded film of any of the first through fourteenth aspects, in which the exterior finishing layer comprises a polyolefin material.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

It will be apparent in combination with the claims and drawings that use of the singular also includes the possibility of the plural. For example, reference to an oil barrier layer also implicitly includes reference to at least one oil barrier layer.

1-15. (canceled)

16. A multilayer coextruded film comprising:
at least one oil and grease absorbing layer, wherein the at least one oil and grease absorbing layer comprises at least one styrenic block copolymer; and
at least one oil barrier layer, wherein each oil barrier layer comprises one or more polyolefins.

17. The multilayer coextruded film of claim 16 further comprising an interior sealing layer.

18. The multilayer coextruded film of claim 17 further comprising an exterior finishing layer, where the at least one oil barrier layer and the at least one oil and grease absorbing layer are disposed between the interior sealing layer and the exterior finishing layer.

19. The multilayer coextruded film of claim 17 where at least one of the oil and grease absorbing layers is disposed between the interior sealing layer and the at least one oil barrier layer.

20. The multilayer coextruded film of claim 17 where at least one of the oil barrier layers is disposed between the interior sealing layer and the at least one oil and grease absorbing layer.

21. The multilayer coextruded film of claim 16 where at least one oil and grease absorbing layer includes an interior sealing layer at an interior surface.

22. The multilayer coextruded film of claim 16 where the at least one oil and grease absorbing layer comprises a blend of styrenic block copolymers and polyolefins.

23. The multilayer coextruded film of claim 16 where the at least one oil and grease absorbing layer comprises a blend of styrenic block copolymers and polyolefins selected from polyethylene or polypropylene.

24. The multilayer coextruded film of claim 16 where the at least one oil and grease absorbing layer comprises a blend of styrenic block copolymers and polyethylene.

25. The multilayer coextruded film of claim 16 where the at least one oil and grease absorbing layer further comprises maleic-anhydride grafted polyolefin.

26. The multilayer coextruded film of claim 26 where the styrenic block copolymer is selected from styrene-butadiene-styrene, styrene-isoprene-styrene, styrene-ethylene/butylene-styrene, or combinations thereof, or particularly styrene-butadiene-styrene.

27. The multilayer coextruded film of claim 16 where the at least one oil and grease absorbing layer comprises 5 to 99% by weight styrenic block copolymer, or particularly 20 to 70% by weight styrenic block copolymer.

28. The multilayer coextruded film of claim 16 wherein the at least one oil and grease absorbing layer comprises 20 to 50% by weight styrene-butadiene-styrene, 35 to 65% by weight polyethylene, and 5 to 25% by weight maleic-anhydride grafted polyolefin.

29. The multilayer coextruded film of claim 16 where the at least one oil barrier layer comprises 20 to 99% polyethylene, the polyethylene selected from high density polyethylene, medium density polyethylene, linear low-density polyethylene, ultra-low density polyethylene, or combinations thereof.

30. The multilayer coextruded film of claim 17 where the interior sealing layer comprises a polyolefin material.

31. The multilayer coextruded film of claim 18 where the exterior finishing layer comprises a polyolefin material.

32. The multilayer coextruded film of claim 18 where the interior sealing layer comprises a polyolefin material.

33. The multilayer coextruded film of claim 22 where the at least one oil and grease absorbing layer further comprises maleic-anhydride grafted polyolefin.
